(19) United States
(12) Patent Application Publication
(10) Pub. No.: US 2005/0187984 A1
(43) Pub. Date: Aug. 25, 2005

(54) Data driven database management system and method

(76) Inventor: Tianlong Chen, Gaithersburg, MD (US)

Correspondence Address: DEWITT ROGGIN PLLC, 12 E. LAKE DRIVE, ANNAPOLIS, MD, 21403, US

(21) Appl. No.: 11/044,698

(22) Filed: Jan. 27, 2005

Related U.S. Application Data
(60) Provisional application No. 60/546,233, filed on Feb. 20, 2004.

(51) Int. Cl. G06F 7/00

(52) U.S. Cl. 707/200

(57) ABSTRACT

A data-driven database management system in which data may be stored in memory rather that on a hard-disk drive. The data may be stored using memory address pointers and address off-sets. A user may define previously unknown data storage styles and implement plug-in logic for accessing such data of a previously unknown data style.

### CROSS-REFERENCE TO RELATED APPLICATIONS

This application claims the benefit of the filing date of U.S. Provisional Application Ser. No. 60/546,233 filed on Feb. 20, 2004 and entitled “Data Driven Database Management System.

Memory-Resident Database Management System and Implementation Thereof; Ser. No. 10/347,678; Filed on Jan. 22, 2003; Inventors: Tianlong Chen, Jonathan Vu.

Distributed Memory Computing Environment and Implementation Thereof; application Ser. No. 10/347,677, Filed on Jan. 22, 2003; Inventors: Tianlong Chen, Jonathan Vu, Yingbin Wang.

Invariant Memory Page Pool and Implementation Thereof; Ser. No. 10/425,730, Filed on Apr. 30, 2003; Inventors: Tianlong Chen, Yingbin Wang, Yinong Wei.

Central Linked List Data Structure and Methods of Use; Filed Jul. 9, 2002, U.S. Pat. No. 6,785,674; Inventor: Jonathan Vu.

A Method and or System to Perform Automated Facial Recognition and Comparison Using Multiple 2D Facial Images Parsed from a Captured 3D Facial Image; Ser. No. 10/757,144, filed on Jan. 14, 2004 and claiming the benefit of U.S. Provisional Application No. 60/440,338 filed on Jan. 16, 2003; Inventors: Donald A. Milne, III and Jonathon Vu.

Image Indexing Search and Implementation Thereof; U.S. patent application Ser. No. 10/718,738 filed on Nov. 21, 2003 claiming the benefit of U.S. Provisional Patent Application Ser. No. 60/454,315 filed on Mar. 14, 2003; Inventors: Tianlong Chen, Yi Rui, Yingbin Wang, and Yinong Wei.

Single Computer Distributed Computing Method and Apparatus for Facial Identification Enhancement; U.S. patent application Ser. No. 10/425,729; filed on Apr. 30, 2003; Inventors: Tianlong Chen, Donald A. Milne, Iii, Yi Rui, Yingbin Wang, Jonathan Vu, And Yinong Wei.

Integrated Portable Identification and Verification Device; U.S. patent application Ser. No. 10/635,516; filed on Aug. 5, 2003; Inventors: Donald Milne, III and Tianlong Chen.

The entirety of each of the aforementioned patents and applications is incorporated by reference herein.

### STATEMENT REGARDING FEDERALLY SPONSORED RESEARCH OR DEVELOPMENT

Not applicable.

### FIELD OF THE INVENTION

The present invention is related to a new type of database management system and more particularly to a data driven database system and its implementation.

### BACKGROUND OF THE INVENTION

Traditional database management systems such as relational database management systems are rather well-defined in not only query statements but also data storage structures such as tables, which are typical of disk-based databases.

When memory becomes cheaper and cheaper, memory-based databases will become the main trend of the database industry. A memory-based database is not just faster than disk-based database because of memory being faster than disk, but also it has other characteristics distinguishing it from disk-based databases. One distinguishing characteristic is that one can use memory address pointers directly to represent a relationship between data, which normally is not available or not easily available in a disk-based database, and one can embed the business logic into database system to directly manipulate data and data relationship. Such characteristics make it easy to build more complicated data storage structure and database management system.

The present invention utilizes the uniqueness of memory-based databases in a new type of database management system, i.e., a data-driven database management system.

Traditional databases, and especially relational databases, use table-like data structures and also use tables as a data storage format. However, a table-like data structure may not be the best data structure and storage format for data searching. The present invention of a data-driven database provides a flexible data management system for various data search and management needs.

### SUMMARY OF THE INVENTION

The present invention disclosed and claimed herein is a method and system for constructing a new type of database management system in which a user of the database can map their desired data structure into the database management directly.

In still another aspect of the disclosed embodiment, a method of mapping a data structure into a database management system is disclosed.

In still another aspect of the disclosed embodiment, a method of inserting matching logic into a database management system for matching the mapped data is disclosed.

Still other aspects, features, and advantages of the present invention are readily apparent from the following detailed description, simply by illustrating preferable embodiments and implementations. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

For a more complete understanding of the present invention and the advantages thereof, reference is now made to the following description and the accompanying drawings, in which:

FIG. 1 illustrates a conceptual block diagram of the basic concept of the Data-Driven Database Management (DDDM).

FIG. 2 illustrates a conceptual block diagram of the basic concept of data matching in the Data-Driven Database Management.

FIG. 3 illustrates a conceptual block diagram of the data mapping for a data tree relationship in the Data-Driven Database Management.

FIG. 4 illustrates a conceptual block diagram of the data mapping for a sorted linked list relationship in the Data-Driven Database Management.

FIG. 5 illustrates a conceptual block diagram of the traditional database management system architecture.

FIG. 6 illustrates a conceptual block diagram of the Data-Driven Database Management System architecture.

### DESCRIPTION OF THE PREFERRED EMBODIMENT

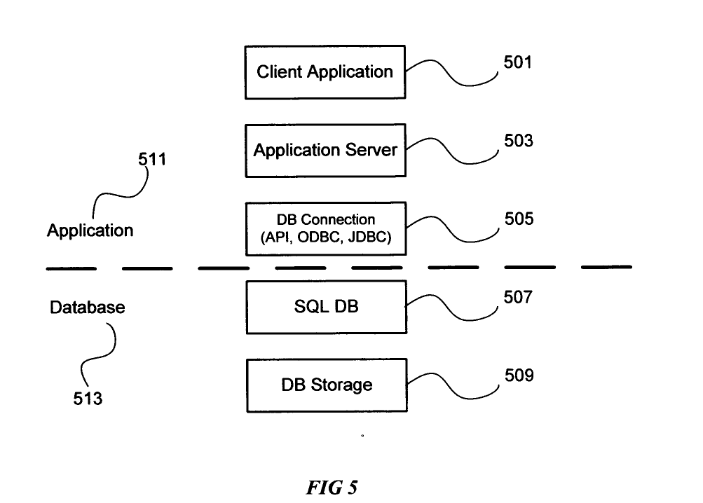

FIG. 5 illustrates a most commonly used application architecture that involves a database management system, in which a customer client application 501 connects through an application server 503 to access database 513. The application server 503 is an optional layer in some application environment. In an environment without application server 503, client application 501 can directly access database 513 through DB Connection layer 505, which is either direct API (Application Programming Interface), ODBC or JDBC. In the case that application server 503 does exist, the DB Connection layer 505 may reside inside application server 503. Then data access uses SQL 507 database language to access data storage 509 for query, update or delete operations. In conventional systems, the business logic is built in client application 501, or more likely in application server 503. Regardless what kind of application is used in such conventional systems, the underlying data storage format, that is how data is stored in the database management system, is fixed to be a table or its variations, and the data storage format cannot be changed.

However, given any business logic, the default data storage format may not be the best storage format for fast data access, and the business logic is normally indirectly connecting to the data storage through various overhead layers such as the application server.

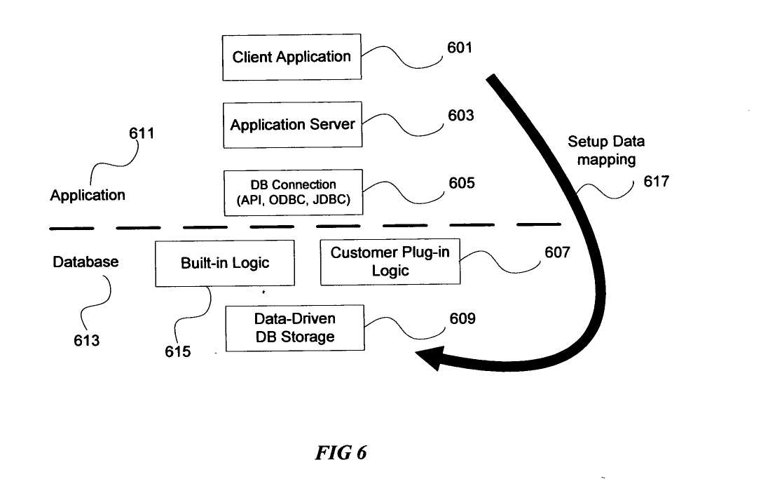

Referring to FIG. 6, the present invention shows a new type of database management architecture in which the data storage format inside data storage 609 can be specified (called data mapping 617 herein) by a user before the data is stored into the database 609, and a user a can plug-in his own logic 607 into the database 609 directly to access data based on the data storage format. Such architecture provides more flexibility and faster access time.

Still referring to FIG. 6, such data driven architecture can be used in disk-based database system, however, such architecture is more suitable for a memory-based database management system, because, in memory, a memory address pointer can be used more easily than in a disk-based database management system.

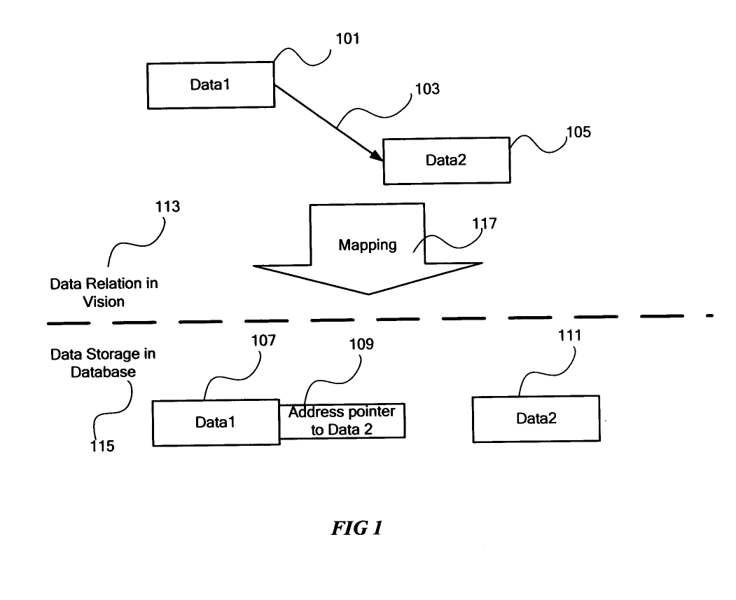

FIG. 1 illustrates a possible method for mapping a data relationship 113 to a data storage format 115. Still referring to FIG. 1, Data1 101 has a relationship 103 with Data2 105, and Data1 101 can be one kind of data type, and Data2 105 can be another kind of data type. When the data relationship is mapped 117 into data storage, it becomes that Data1 101 is mapped to Data1 107 in storage, Data2 105 is mapped Data2 111 in storage and relationship 103 is mapped to a memory address pointer 109 in storage. The address pointer 109 remembers (or called “points to”) the storage location of Data2 111 in storage. When one accesses Data1 107 in the database, the associated memory pointer 109 indicates Data1 107 has “relationship” with Data2 111, and by accessing the address pointed to by the address pointer 109, one can find Data2 111 directly. Besides the address “points to” functionality, the address pointer 109 can also include other relationship information, such as relationship type, relationship access security information etc.

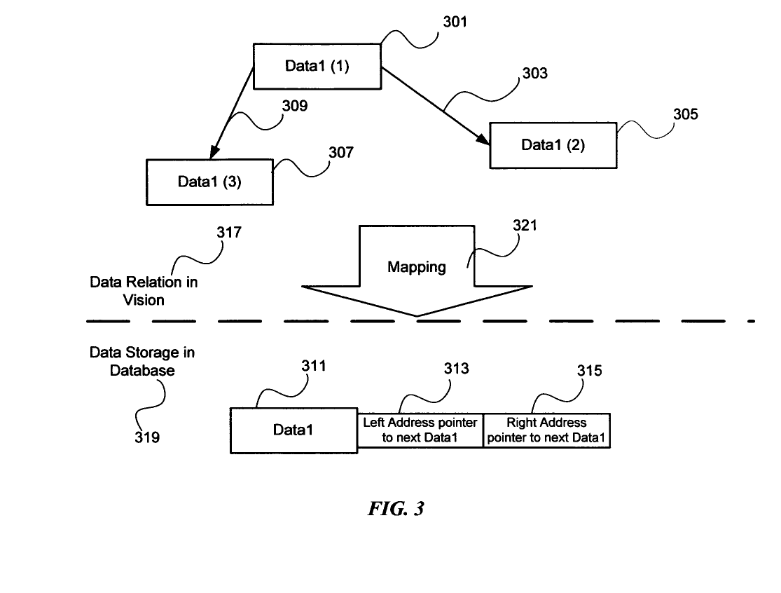

A more complicated data relationship such as a tree structure is illustrated in FIG. 3, where all data are of same data type Data1, and Data1 (1) 301 has a relationship 303 with right child Data1 (2) 305 and a relationship 309 with left child Data1 (3) 307. Each data of Data1 type, can be mapped 321 from vision concept 317 into a data storage 319 format Data1 311 in storage with Left Address pointer 313 and Right Address pointer 315, where Left Address pointer 313 can be stored one unit offset from Data1 311, and Right Address pointer 315 can be stored two units offset from Data1 311. When one accesses Data1 311, by accessing its Left Address pointer 313, one can find the storage location of its left child and by accessing its Right Address pointer 315, one can find the storage location of its right child. Again address pointers 313, 315 can include other relationship information.

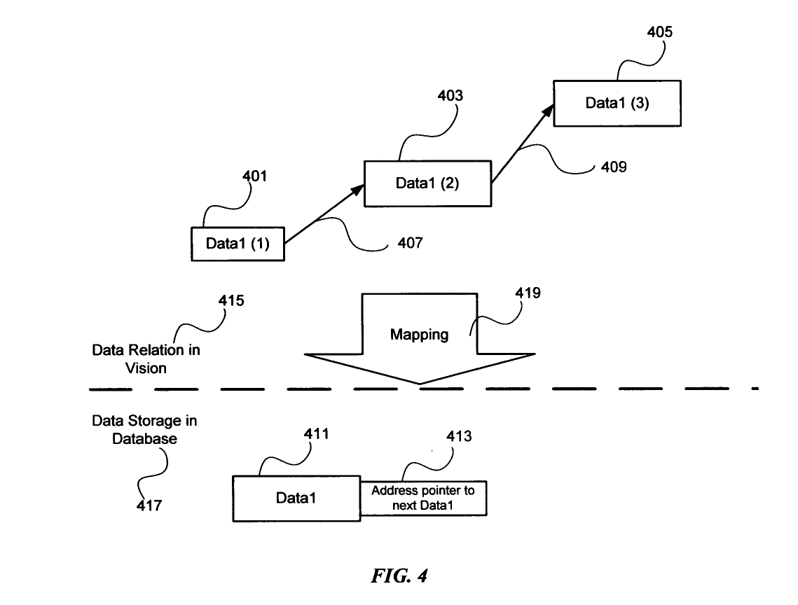

A data relationship such as a linked list is illustrated in FIG. 4, where all data are of same data type Data1, and Data1 (1) 401 links 407 to Data1 (2) 403 and Data1 (2) 403 links 409 to Data1 (3) 407. Therefore each data of Data1 type, can be mapped 419 from vision concept 415 into a data storage 417 format Data1 411 in storage with a link pointer 413. When one accesses Data1 411, by accessing link pointer 413, one finds the storage location of its next linked node.

In order to rebuild the in-memory data storage from a backup or for a faster recovery, referring to Patent Application “Memory-Resident Database Management System and Implementation Thereof” filed on Jan. 22, 2003 by Tianlong Chen and Jonathan Vu with U.S. patent application Ser. No. 10/347,678, one can, preferably, use a relative memory address mapping schema like the DMCE Virtual Address, into the said data mapping in this invention. One can also refer to that Patent application and the other Patent applications referenced above for descriptions of underlying memory management.

Referring to FIG. 6, it will make more sense that a user of the Data-Driven Database can use his/her own logic 607 to access the data directly after he/she maps the data and data relationship from vision into storage; because the user may know better what he/she wants to do with the stored data.

Still referring to FIG. 6, the present invention provides a preset Application Programming Interface (API) for application 611 (including 601 603 605) to plug-in its own logic functionality 607 to access the mapped data and data relationship in the data storage 609. For most commonly used data styles, such tables, trees, and linked-lists, application 611 can use built-in database logic functionality 615 to access the mapped data in the data storage 609. Of course application 611 can combine both built-in 615 and customer plug-in logic 607 to achieve its data access and manipulation requirement. Before the data is actually stored into data storage 609, the data mapping scheme 617 should be set.

Still referring to FIG. 6, since all data access and manipulation logic whether it is built-in 615 or customer-plug-in 607 is based on a preset API, the database management system therefore can provide all necessary basic functionality that any other database normally has such as “data read”, “data write”, “data add”, “data update”, “delete data”, and can also provide other unique data access methods such as accessing data by following an address pointer and finding an address pointer by location offset, which is normally used in software coding such as C language. Since the data storage format is mapped before data is stored, the location offset is known for later access. Besides the preset API provided by the present database management system, the user can use virtually any logic based on its data access and manipulation need, which can be chosen as a limited option as such plugged-in logic may have stability and security concerns.

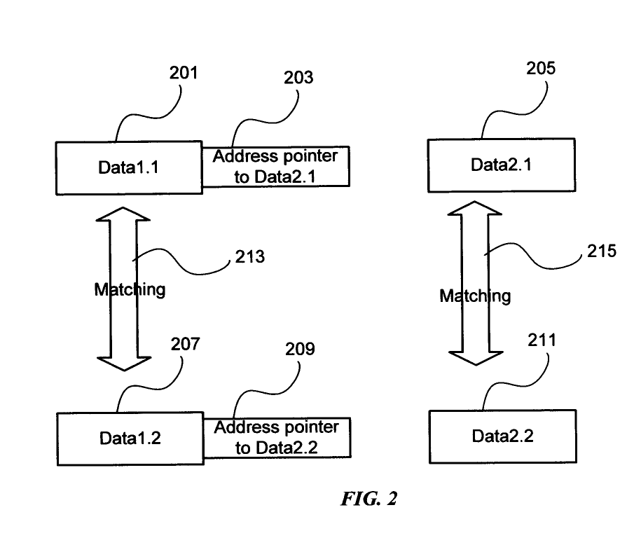

Referring to FIG. 2, another benefit of such database system is that one can provide a new data type which previously was not known by the database. Then, one of most important logic functionalities that a user must provide for such a new data type is to provide plug-in logic 213, 215 to manipulate mapped data such as to compare two mapped data of the same data type such as Data1.1 201 verse Data1.2 207, and Data2.1 205 verse Data2.2 211. The comparison result can be sense of“larger”, “equal to” and “smaller”.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

1. A method for implementing a comprehensive in-memory database management system, comprising the steps of:
providing that data and data relationship is mapped into data storage and said relationship can be mapped by a relative memory address pointer;
providing that user can plug-in or embed its customized logic to access and manipulate said mapped data and data relationship in said data storage;
providing that said in-memory database management system resides in a computer system, and said computer system having at least a memory block.

2. A method according to claim 1 wherein said relative memory address pointer at least comprises an offset from the starting address of a said memory block.

3. A method according to claim 1 wherein said data and data relationship storage mapping can be configured by user.

4. A method according to claim 1 wherein said database management system provides built-in logic to access commonly used data types and associated data relationships.

5. A method according to claim 1 wherein user can specify a new data type and its data and data relationship storage mappings in said database management system.

6. A method according to claim 5 wherein said user will be required to provide a plug-in or embedded logic to manipulate said new data type.

7. A method according to claim 6 wherein said manipulation logic at least includes a method to compare two data which are of said new data type;

8. A method according to claim 7 wherein the result from said comparison should include sense of “larger”, “equal to” and “smaller”.

9. A method according to claim 1 and claim 4 wherein said user can build its logic from said built-in logic and its other said user-plug-in logic.

10. A method according to claim 1 wherein said mapped data and data relationship storage can be accessed by memory offset.

11. A method according to claim 1 wherein said plug-in logic will follow preset API.

12. A method according to claim 11 and claim 1 wherein said preset API includes data read from said data storage.

13. A method according to claim 11 and claim 1 wherein said preset API includes data write to said data storage.

14. A method according to claim 11 and claim 1 wherein said preset API includes data update to said data storage.

15. A method according to claim 11 and claim 1 wherein said preset API includes data delete from said data storage.

16. A method according to claim 1 wherein one data in said database management system can be accessed by following the said memory address pointer from another data.

17. A method according to claim 1 wherein said memory address pointer can include other relationship information about said data.

18. A method according to claim 17 wherein said other relationship information may include access security information.

19. A method according to claim 3 wherein said configurable storage mapping includes storage format.

20. A method according to claim 1 wherein said in-memory database management system has a visualized representation of said storage mapping of said data and data relationships.

21. A method according to claim 1 and claim 20 wherein user can make change to the said storage mapping of said data and data relationship by changing said visualized representation.

22. A method according to claim 2 wherein said relative memory address further comprises an ID to said memory block.

23. A method according to claim 5 wherein said specification further includes the size of said new data type.

24. An in-memory database management system comprising:
a computer system having a processor and a memory;
a database stored in said memory, said database comprising a plurality of data;
means for mapping said plurality of data and a plurality of data relationships in said memory with a relative memory address pointers; and
means for accessing and manipulating said mapped data and data relationship in said memory.

25. An in-memory database management system according to claim 24 wherein said relative memory address pointer comprises an offset from a starting address of a memory block in said memory.

26. An in-memory database management system according to claim 24 wherein said means for mapping is configurable by a user.

27. An in-memory database management system according to claim 24 further comprising built-in logic for accessing commonly used data types and associated data relationships.

28. An in-memory database management system according to claim 27 further comprising a plug-in logic for manipulating a data type specified by a user.

29. An in-memory database management system according to claim 26 wherein said means for mapping further comprising storage format of said data and data relationships.

30. An in-memory database management system according to claim 24 further comprising means for a user to specify a new data type and associated data relationships.

31. An in-memory database management system according to claim 30 further comprising means for a user to plug-in logic to access said new data type and said associated data relationships.

32. An in-memory database management system according to claim 30 further comprising means for a user to plug-in logic to manipulate said new data type and said associated data relationships.

33. An in-memory database management system according to claim 24 further comprising means to show a visualized representation of said mapping of said data and data relationships.

34. An in-memory database management system according to claim 33 further comprising means to make changes to said mappings of said data or data relationships through said visualized representation.
